(19) United States
(12) Patent Application Publication
(10) Pub. No.: US 2024/0262729 A1
(43) Pub. Date: Aug. 8, 2024

(54) METHOD AND DEVICE FOR RURAL WASTEWATER RECYCLING

(71) Applicant: Nanjing Hydraulic Research Institute, Nanjing (CN)

(72) Inventors: Xiaojun WANG, Nanjing (CN); Feng CHEN, Nanjing (CN); Jianyun ZHANG, Nanjing (CN)

(21) Appl. No.: 18/637,189

(22) Filed: Apr. 16, 2024

(30) Foreign Application Priority Data
Apr. 18, 2023 (CN) 202310412376.2

(51) Int. Cl. C02F 3/32; B01D 21/24; C02F 1/00; C02F 1/74; C02F 3/00; C02F 103/00; E02F 5/28; E03F 1/00

(52) U.S. Cl. CPC C02F 3/327; B01D 21/245; C02F 1/004; C02F 1/74; C02F 3/006; E02F 5/285; E03F 1/002; C02F 2001/007; C02F 2103/001; C02F 2201/005; C02F 2209/42

(57) ABSTRACT

A rural wastewater recycling device, including a collecting ditch, a moving cover, multiple treatment units, a water storage tank and a biological purification assembly. The collecting ditch has a trapezoidal cross section, and is connected to the moving cover. Adjacent treatment units are communicated, and two terminal treatment units are respectively connected with the collecting ditch and the water storage tank. The water storage tank is configured to store treated water. The biological purification assembly is connected with the treatment units, and is configured to purify wastewater flowing through the treatment units. A rural wastewater recycling method based on such device is also provided.

### CROSS-REFERENCE TO RELATED APPLICATIONS

This application claims the benefit of priority from Chinese Patent Application No. 202310412376.2, filed on Apr. 18, 2023. The content of the aforementioned application, including any intervening amendments thereto, is incorporated herein by reference in its entirety.

### TECHNICAL FIELD

This application relates to water resources utilization and environmental protection technology, and more particularly to a method and device for rural wastewater recycling.

### BACKGROUND

There are various rural decentralized sewage treatment technologies, which are dominated by point-type treatment systems, such as constructed wetlands and sewage treatment pools. However, such treatment systems struggle with high operation and maintenance, and unsatisfactory treatment efficiency.

### SUMMARY

An object of this application is to provide a method and device for rural wastewater recycling to solve problems of high construction and maintenance cost of water treatment facilities, incomplete construction and serious environmental pollution and damage in the prior art.

The present disclosure provides a method for rural wastewater recycling, comprising:
(S1) setting a collecting ditch and a first treatment pool for collecting wastewater around a rural yard; according to a discharge capability Q_{ditch} and a discharge destination of the collecting ditch, determining a gradient of the collecting ditch; wherein the discharge destination comprises the first treatment pool, a river channel and a pond;
(S2) according to the layout and regional topography of the rural yard, arranging n second treatment pools respectively in n levels at a position near the rural yard and lower than the rural yard, wherein bottom elevations of the n second treatment pools are descending with an increase in wastewater treatment degree; volumes of the n second treatment pools are V₁ₗᵢₘ, V₂ₗᵢₘ, V₃ₗᵢₘ, . . . , and Vₙₗᵢₘ, and Vᵢₗᵢₘ=Sᵢ·Hᵢₗᵢₘ, wherein i=1, 2, 3, . . . , n; Sᵢ represents a base area of an i-th second treatment pool; and Hᵢₗᵢₘ represents a maximum water level of the i-th second treatment pool; a total water quantity limit of the n second treatment pools is Q_{total lim}, and Q_{total lim}=Σᵢ₌₁ⁿVᵢ·ρ=Q_{ditch}, wherein ρ represents density of water;
(S3) obtaining water storage information of each of the n second treatment pools; and according to the water storage information and the maximum water level, recycling or discharging water in the n second treatment pools in time;
(S4) calculating a total water demand; according to the total water demand, determining total water storage information of the n second treatment pools; wherein the total water demand is calculated by Rₜₒₜₐₗ=R_{ecology}+R_{flushing}+R_{aquaculture}, wherein R_{ecology}=S·h·(θfc−θwilting), and R_{ecology} represents ecological water demand of plants around the collecting ditch and the n second treatment pools; R_{flushing} and R_{aquaculture} respectively represents flushing water demand and aquaculture water demand for meeting water quality requirements; θfc represents field capacity; and θwilting represents wilting water content; and
(S5) according to water quality, water quantity and environmental protection situations, controlling a total duration T of an operation cycle of collected domestic wastewater between the n second treatment pools and the collecting ditch; and recycling treated wastewater reaching standard or discharging the treated wastewater reaching standard to the river channels or ponds.

In an embodiment, the discharge capability Q_{ditch} of the collecting ditch is calculated as follows:

$$\begin{matrix}{Q}_{ditch} = max ( {Q}_{r a i n} , {Q}_{s e w a g e} ) ; \\ {Q}_{rain} = α \cdot A \cdot q ; \\ {Q}_{sewage} = {Q}_{c s} + {Q}_{d s} ; and \\ {Q}_{d s} = K \cdot {q}_{quota} \cdot N ;\end{matrix}$$

wherein Qᵣₐᵢₙ represents rainfall; a represents runoff coefficient; A represents catchment area; q represents rainfall intensity; K represents sewage discharge coefficient; q_{quota} represents domestic sewage quota; Q_{cs} represents culture sewage quantity; Q_{ds} represents domestic sewage quantity; and N represents population size.

In an embodiment, in step (S5), in the case of no rain, performing wastewater treatment in accordance with a conventional operation cycle T; adopting part of treated wastewater reaching flushing or greening standard for plant irrigation, flushing or aquaculture, and maintaining a certain water level in the collecting ditch and the n second treatment pools; and
in the case of rainfall, according to drainage requirements, shortening the operation cycle T; filtering collected rainwater, and discharging excess wastewater reaching standard to the river channel or pond; wherein the operation cycle T is calculated as follow: T=Σᵢ₌₁ⁿtᵢ; wherein tᵢ is residence time of collected domestic wastewater in the i-th second treatment pool, and i=1, 2, 3, . . . , n.

The present disclosure also provides a rural wastewater recycling device, comprising:
a collecting ditch;
a moving cover;
a plurality of treatment units;
a water storage tank; and a biological purification assembly;
wherein the collecting ditch is configured for connection with a wastewater generation site, and a cross section of the collecting ditch is trapezoidal; the moving cover is connected with the collecting ditch; adjacent treatment units of the plurality of treatment units are communicated with each other; one of the plurality of treatment units located at a first end is connected with the collecting ditch; and for two adjacent treatment units among the plurality of treatment units, a treatment unit close to the wastewater generation site is higher than the other treatment unit; one of the plurality of treatment units located at a second end is communicated with the water storage tank, the water storage tank is configured to store treated water; the biological purification assembly is connected with the plurality of treatment units, and is configured to purify wastewater flowing through the plurality of treatment units.

In an embodiment, each of the plurality of treatment unit comprises:
a first treatment pool;
a second treatment pool;
a guiding ditch;
a control valve; and a control unit;
wherein a first end of the first treatment pool is communicated with the collecting ditch through a first inlet ditch, and a second end of the first treatment pool is communicated with an adjacent treatment unit or the water storage tank through a first outlet ditch; the first outlet ditch is communicated with the first treatment pool through a water outlet;
a first end of the second treatment pool is communicated with the collecting ditch through a second inlet ditch, and a second end of the second treatment pool is communicated with the adjacent treatment unit or the water storage tank through a second outlet ditch;
a first end of the guiding ditch is communicated with the first treatment pool, and a second end of the guiding ditch is communicated with the second treatment pool; a connection position between the guiding ditch and the first treatment pool is lower than the water outlet;
the control valve is arranged between the guiding ditch and the first treatment pool, and is configured to control connection and disconnection between the first treatment pool and the guiding ditch; and
the control unit is connected with the first inlet ditch and the second inlet ditch; and the control unit is electrically connected with the control valve, and is configured to control connection and disconnection between the collecting ditch and the first inlet ditch, and connection and disconnection between the collecting ditch and the second inlet ditch, respectively.

In an embodiment, the rural wastewater recycling device comprises a sludge-removing assembly connected with the plurality of treatment units;
wherein the sludge-removing assembly comprises:
a shovel;
a support rod;
a transmission rod; and a drive component;
wherein the shovel is provided in the first treatment pool or the second treatment pool, and is configured to remove sludge in the first treatment pool or the second treatment pool; the support rod is slidably connected with the shovel; the support rod is provided with a support sliding hole; the shovel is provided through the support rod through the support sliding hole, and is configured to slide along a direction perpendicular to the support rod; the transmission rod is connected with the support rod; the number of transmission rod is two, and two transmission rods are respectively provided at two sides of the first treatment pool or two sides of the second treatment pool; the two transmission rods are configured to drive the support rod to move along an arrangement direction of the two transmission rod; and the drive component is connected with the two transmission rods, and is configure to drive the two transmission rods to rotate.

In an embodiment, the biological purification assembly comprises:
a filter mesh box;
a filter ball; and
a plant filter layer;
wherein the filter mesh box is connected with the first treatment pool or the second treatment pool; both the first treatment pool and the second treatment pool are respectively provided with a mounting groove fitting the filter mesh box; the filter mesh box is provided with an accommodating cavity; the filter ball is provided in the accommodating cavity, and is configured to filter wastewater; the plant filter layer is provided in the accommodating cavity and floating on a water surface; and the plant filter layer is configured to filter wastewater.

In an embodiment, the shovel comprises:
a support body; and
a shovel body;
wherein the support body comprises a first sliding part, a first support part and a second support part; the first sliding part is slidably connected with the support rod; an end of the first sliding part is provided with a tab in snap-fit with the support rod; the first support part is integrally formed with the first sliding part and the second support part; the first support part is perpendicular to the second support part; the first support part is provided with a support sliding groove; a cross section of one end of the second support part away from the first support part is smaller than a cross section of the other end of the second support part; and
the shovel body comprises a second sliding part and a shoveling part; the second sliding part is slidably connected with the support body through the support sliding groove; the second sliding part is integrally formed with the shoveling part; the second sliding part is perpendicular to the first support part; the shoveling part is perpendicular to second sliding part; and an end of the shoveling part away from the second sliding part is provided with a shoveling slope.

In an embodiment, the moving cover is made of straw or wrapped plant ash; and/or
the collecting ditch is an integrated ecological slope whose materials comprise shrub, stone and brick.

In an embodiment, the sludge-removing assembly is provided with an aerator connected with the support rod; the aerator is communicated with the support body through a pipeline; and the support body is provided with a plurality of aeration holes.

Compared to the prior art, the rural wastewater recycling method and device provided herein have the following beneficial effects.

(1) This application enables the recycling of rural wastewater through the multi-level treatment, which can effectively solve the disordered rural wastewater discharge, reduce non-point source pollution, and create a clean and tidy living environment, especially for rural areas far from central village and town with small population and scattered residence.

(2) Through the real-time monitoring and regulation of the whole rural wastewater treatment and recycling process, the fresh water supply is reduced, and the efficient recycling of wastewater is realized, which can effectively reduce the costs. At the same time, the rural wastewater recycling method and device are implemented according to actual situations, and adopt local plants for construction, which effectively controls the costs and is conducive to the widespread promotion.

(3) Through constructing the collecting ditch, treatment pools and micro-river channel wetland unit in and near which native plants and algae are planted and grown, the treatment time of rural wastewater can be extended, and the nutrient circulation is enhanced, which can promote absorption and utilization of nitrogen and phosphorus by plants in the ditches and pools, thereby forming a multi-layer and healthy biological community, and protecting the regional biodiversity.

The present disclosure solves problems of high construction cost and difficult operation and maintenance of water treatment facilities existing in the prior art, and exhibits remarkable effects in terms of promoting efficient utilization of water resources and improving rural living environment.

### BRIEF DESCRIPTION OF THE DRAWINGS

To facilitate the understanding of technical solutions of embodiments of the present disclosure or the prior art, accompanying drawings needed in the description of embodiments or the prior art will be briefly introduced below. It is obvious that presented in the accompanying drawings are only some embodiments of the present disclosure, and those skilled in the art can obtain other drawings according to these accompanying drawings without any creative effort.

FIG. 1 is a block flow diagram of a rural wastewater recycling method according to an embodiment of the present disclosure.

FIG. 2 is a structural block diagram of a rural wastewater recycling device according to an embodiment of the present disclosure.

FIG. 3 schematically shows a structure of treatment units of the rural wastewater recycling device according to an embodiment of the present disclosure in a horizontal direction.

FIG. 4 schematically shows a structure of the rural wastewater recycling device according to an embodiment of the present disclosure.

FIG. 5 is a front view of the treatment unit according to an embodiment of the present disclosure.

FIG. 6 is a sectional view of the treatment unit in FIG. 5 along A-A line.

FIG. 7 is a structural diagram of the treatment unit according to an embodiment of the present disclosure.

FIG. 8 is a structural diagram of a control unit of the rural wastewater recycling device according to an embodiment of the present disclosure.

FIG. 9 is a structural diagram of a sludge-removing assembly of the rural wastewater recycling device according to an embodiment of the present disclosure.

In the figures: 1, collecting ditch; 2, treatment unit; 3, water storage tank; 4, biological purification assembly; 5, sludge-removing assembly; 6, aerator; 7, pumping-drainage device; 21, first treatment pool; 22, second treatment pool; 23, guiding ditch; 24, control valve; 25, control unit; 26 first inlet ditch; 27, first outlet ditch; 28, second inlet ditch; 29, second outlet ditch; 41, filter mesh box; 42, filter ball; 43, plant filter layer; 51, shovel; 52, support rod; 53, transmission rod; 54, first drive component; 55, solar battery; 56, jacking part; 251, first support frame; 252, first isolation block; 253, second support frame; 254, second isolation block; 255, control frame; 256, control belt; 257, second drive component; 258, first connecting rope; 259, second connecting rope; 411, accommodating cavity; 511, support body; and 512, shovel body.

### DETAILED DESCRIPTION OF EMBODIMENTS

The present disclosure will be clearly and completely described below with reference to the accompanying drawings and embodiments. It is obvious that described herein are only some embodiments of the present disclosure rather than all embodiments. Any other embodiments made by those skilled in the art based on the embodiments provided herein without creative effort shall fall within the scope of the present disclosure.

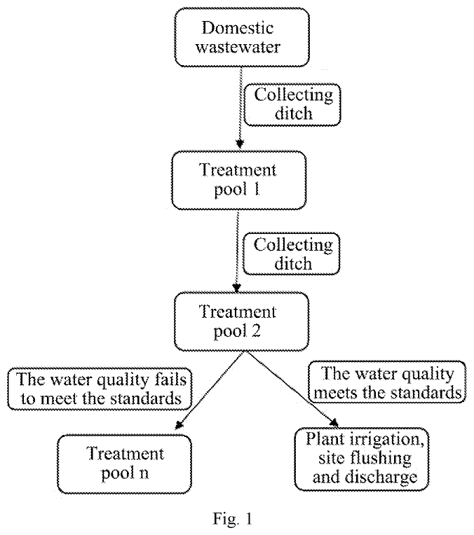

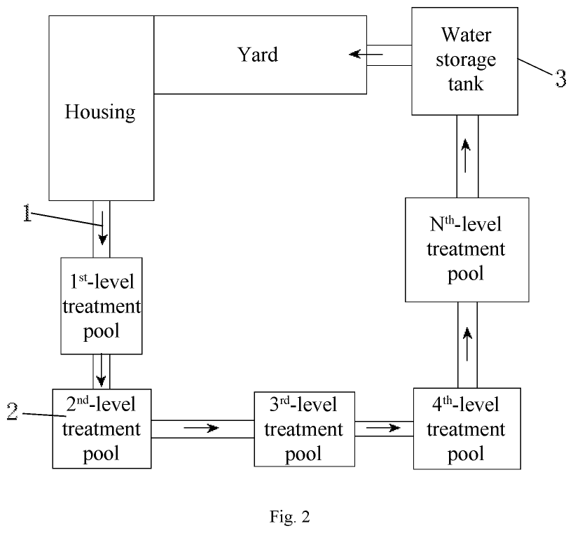

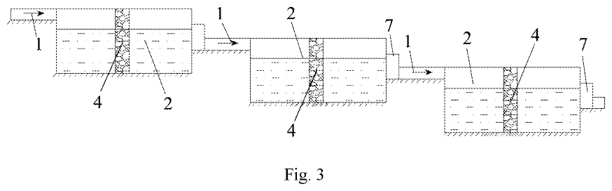

Referring to FIGS. 1-3, a rural wastewater recycling method of the present disclosure will be described below with reference to a specific embodiment, including the following steps.

(S1) A collecting ditch 1 and a first treatment pool for collecting wastewater are set around a rural yard. Phosphorus-containing wastewater and non-phosphorus-containing wastewater are collected. According to a discharge capability Q_{ditch} and a discharge destination of the collecting ditch 1, a gradient of the collecting ditch 1 is determined, where the discharge destination includes the first treatment pool, a river channel and a pond.

In step (S1), the discharge capability Q_{ditch} of the collecting ditch 1 is expressed as follows:

$$\begin{matrix}{Q}_{ditch} = max ( {Q}_{r a i n} , {Q}_{s e w a g e} ) ; \\ {Q}_{rain} = α \cdot A \cdot q ; \\ {Q}_{sewage} = {Q}_{c s} + {Q}_{d s} ; and \\ {Q}_{d s} = K \cdot {q}_{quota} \cdot N ;\end{matrix}$$

where Qᵣₐᵢₙ represents rainfall; a represents runoff coefficient of a local area; A represents catchment area; q represents designed rainfall intensity; K represents sewage discharge coefficient, which is generally 0.6˜0.9, with a small value in the north and a large value in the south; q_{quota} represents domestic sewage quota, and a normal amount of domestic sewage of a rural resident (an adult) in 24 hours is usually 50-250 L (which can be adjusted according to regional seasons and other conditions); N represents population size; Q_{cs}, represents culture sewage quantity; and Q_{ds} represents domestic sewage quantity; under normal circumstances, Q_{ditch} is usually dominated by Qᵣₐᵢₙ in rainy areas and Q_{sewage} in dry and low rainfall areas; according to the Q_{ditch}, a depth and bottom width of the collecting ditch 1 can be determined, so as to determine a discharge area.

(S2) According to the layout and regional topography of rural yard, n second treatment pools are arranged respectively in n levels at a position near the rural yard and lower than the rural yard, where bottom elevations of the n second treatment pools are descending with an increase in wastewater treatment degree. Volumes of the n second treatment pools are V₁ₗᵢₘ, V₁ₗᵢₘ, V₃ₗᵢₘ, . . . , and Vₙₗᵢₘ, and Vᵢₗᵢₘ=Sᵢ·Hᵢₗᵢₘ, where i=1, 2, 3, . . . , n; Sᵢ represents a base area of an i-th second treatment pool; and Hᵢₗᵢₘ represents a maximum water level of the i-th second treatment pool. A total water quantity limit of the n second treatment pools is Q_{total lim}, and Q_{total lim}=Σᵢ₌₁ⁿ·Vᵢ·ρ=Q_{ditch}, where ρ represents density of water.

Soil ponds are mostly used in the n second treatment pools, and comprehensive protection (hard slope protection+plant protection) is set in places prone to soil collapse. Local varieties of shrubs, grasses and algae with strong adsorption capacities are planted along edges of the n second treatment pools.

(S3) Water storage information of the n second treatment pools is obtained. According to the water storage information and the maximum water level, water in the n second treatment pools is recycled or discharged in time.

Water quality monitoring, filtration, blocking and a pumping-drainage device 7 are set at an inlet and outlet of each of the n second treatment pools, that is, a water quantity sensor, a flow meter, a block, a water pump and other components are set. The water quantity sensor is configured to monitor water pollutant content at a certain point in real time. The flow meter is configured to measure a flow velocity. The block is configured to control a water quantity flowed in and out. The water pump is provided as the pumping-drainage device 7 in a storage regulating pool, and is configured to regulate water between each of the n second treatment pools and the collecting ditch 1, regulate water between each of the n second treatment pools and drain water outward, so as to realize wastewater recycling and efficient utilization. The storage regulating pool is a water storage tank 3 of a device for recycling rural wastewater of the present disclosure.

(S4) A total water demand is calculated. According to the total water demand, total water storage information of the n second treatment pools is determined, where the total water demand is calculated by Rₜₒₜₐₗ=R_{ecology}+R_{flushing}+R_{aquaculture}, where R_{ecology}=S·h·(θfc−θ_{wilting}); R_{ecology} represents ecological water demand of plants around the collecting ditch and the n second treatment pools; R_{flushing} and R_{aquaculture} respectively represents flush water demand and aquaculture water demand for meeting water quality requirements; S represents an area of surrounding shrub and grass; h represents depth of plant root, which is in a range of 10 cm-80 cm; θfc represents field capacity; and θ_{wilting} represents soil wilting water content.

(S5) According to water quality, water quantity and environmental protection situations, a total duration T of an operation cycle of collected domestic wastewater between the n-level treatment pools and the collecting ditch is controlled. Treated wastewater reaching standard is recycled or discharged to the river channel or pond.

In step (S5), in the case of no rain, wastewater treatment is performed in accordance with a conventional operation cycle T. Part of treated wastewater reaching flushing or greening standard is adopted for plant irrigation, flushing or culture, and a certain water level is maintained in the collecting ditch and the n second treatment pools. In the case of rainfall, according to drainage requirements, the operation cycle T is shortened. Collected rainwater is filtered, and wastewater reaching standard is discharged to the river channel or pond, where the operation cycle T is calculated as follow: T=Σᵢ₌₁ⁿtᵢ; where tᵢ is residence time of collected domestic wastewater in the i-th second treatment pool, and i=1, 2, 3, . . . , n.

The total duration T of a cycle of the method for recycling rural wastewater, according to the water quality of the n second treatment pools, is 10-30 days. Sediment and absorption time of each of the n second treatment pools is 1-4 days, which is determined according to an effect before and after treatment. The rural wastewater recycling method uses solar energy, wind energy and battery to supply energy, which is more energy-saving and environmentally-friendly during operation.

Compared to the prior art, the recycling method for rural wastewater collects the domestic wastewater through the collecting ditch 1. The domestic wastewater is initially filtered, enters a first treatment pool for precipitation and biological treatment (adsorption and decomposition of plant algae), enters a second treatment pool through the collecting ditch 1, . . . , and enters an n-th treatment pool finally. Based on dual allocation of water quantity and time, the rural wastewater is treated by strong discharge and artesian flow, and the wastewater reaching standards after treatment is discharged or recycled. The recycling method has the following beneficial effects.

(1) This application enables the recycling of rural wastewater through the multi-level treatment, which can effectively solve the disordered rural wastewater discharge, reduce non-point source pollution, and create a clean and tidy living environment, especially for rural areas far from central village and town with small population and scattered residence.

(2) Through the real-time monitoring and regulation of the whole rural wastewater treatment and recycling process, the fresh water supply is reduced, and the efficient recycling of wastewater is realized, which can effectively reduce the costs.

(3) Through constructing the collecting ditch 1, treatment pools and microchannel wetland unit in and near which native plants and algae are grown, the treatment time of rural wastewater can be extended, and the nutrient circulation is enhanced, which can promote absorption and utilization of nitrogen and phosphorus by plants in the ditches and pools, thereby forming a multi-layer and healthy biological community, and protecting the regional biodiversity.

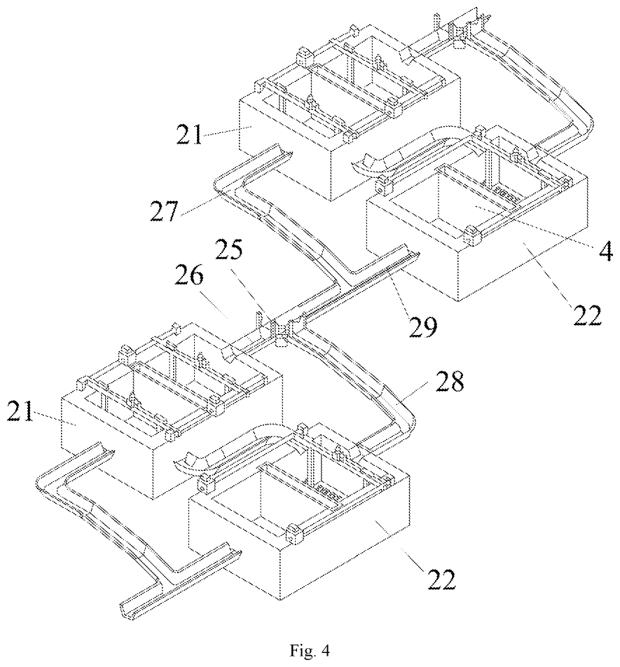

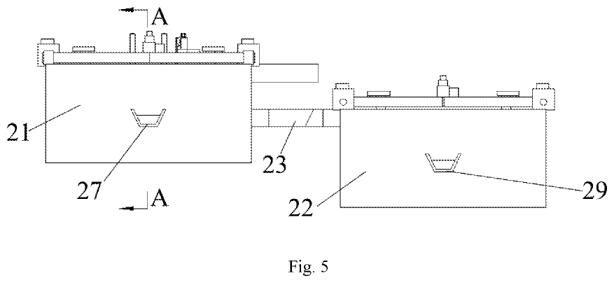

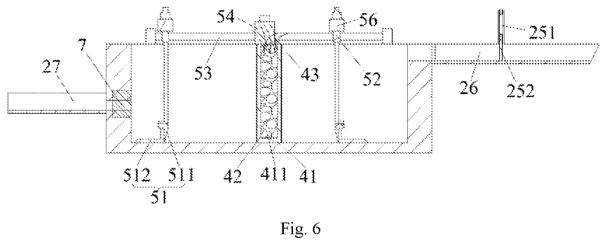

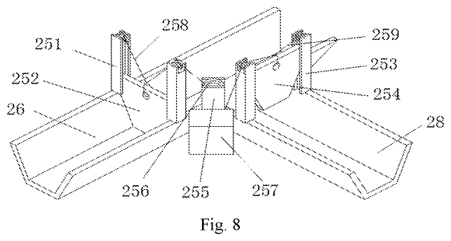

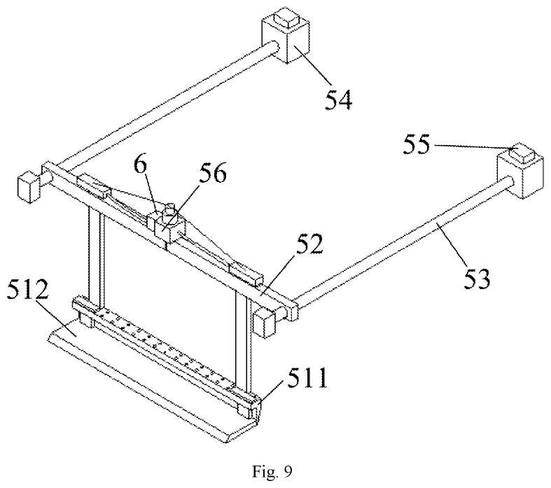

Referring to FIGS. 1-9, a rural wastewater recycling device of the present disclosure will be described below with reference to a specific embodiment. The rural wastewater recycling device is applied on the above method for recycling rural wastewater, including a collecting ditch 1, a moving cover, a plurality of treatment units 2, a water storage tank 3 and a biological purification assembly 4. The collecting ditch 1 is configured for connection with a wastewater generation site, and a cross section of the collecting ditch 1 is trapezoidal. The moving cover is connected with the collecting ditch 1. Adjacent treatment units of the plurality of treatment units are communicated with each other. One of the plurality of treatment units 2 located at a first end is connected with the collecting ditch 1, and for two adjacent treatment units 2 among the plurality of treatment units, a treatment unit 2 close to the wastewater generation site is higher than the other treatment unit 2, such setting ensures that water automatically flows to the next treatment unit 2 without setting a drive device, which saves construction cost. One of the plurality of treatment units 2 located at a second end is communicated with the water storage tank 3. The water storage tank 3 is configured to store treated water. The biological purification assembly 4 is connected with the plurality of treatment units 2, and is configured to purify wastewater flowing through the plurality of treatment units 2.

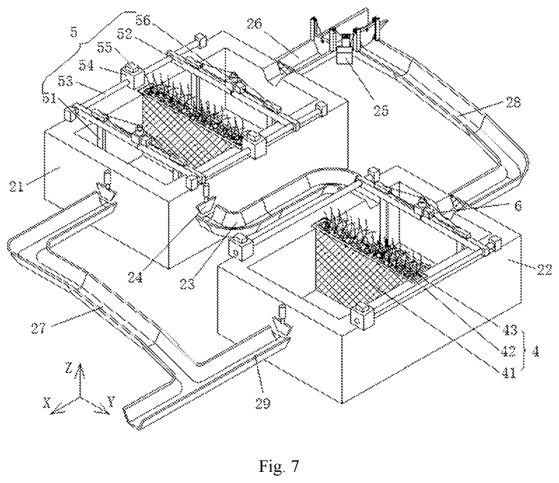

To facilitate description, referring to FIG. 7, a rectangular coordinate system is established with any point in space as an origin, a setting direction of a support rod 52 relative to a shovel 51 as a Z-axis, a setting direction of a first outlet ditch 27 in the treatment unit 2 relative to a first treatment pool 21 an X-axis, and a linear direction perpendicular to the X-axis and Z-axis as a Y-axis, where an XY plane is a horizontal plane, a direction indicated on the horizontal plane is a horizontal direction, and an indicated direction on the Z-axis is a vertical direction.

In this embodiment, the moving cover is made of straw or wrapped plant ash with a thickness of about 2-5 cm, which is easy to absorb odors of domestic wastewater.

A moving track is arranged between the moving cover and the ground, and the moving cover is configured to slide on the moving track to shield and open the collecting ditch 1. A side slope of the collecting ditch 1 is an integrated ecological slope made of local shrub, stone and brick, which is consistent with rural yard buildings.

Compared to the prior art, the rural wastewater recycling device is implemented according to actual situations, and according to local topography, adopts local plants for construction, which effectively controls the costs and is conducive to widespread promotion. The rural wastewater recycling device also solves problems of high construction cost and difficult operation and maintenance of water treatment facilities existing in the prior art, provides technical support for promoting efficient utilization of water resources and effectively improving rural living environment.

In an embodiment, a structure of the rural wastewater recycling device provided herein is basically the same as a structure of the rural wastewater recycling device in the above embodiment, except that the treatment unit 2 includes a first treatment pool 21, a second treatment pool 22, a guiding ditch 23, a control valve 24 and a control unit 25. A first end of the first treatment pool 21 is communicated with the collecting ditch 1 through a first inlet ditch 26, and a second end of the first treatment pool 21 is communicated with an adjacent treatment unit 2 or the water storage tank 3 through a first outlet ditch 27. The first outlet ditch 27 is communicated with the first treatment pool 21 through a first water outlet. A first end of the second treatment pool 22 is communicated with the collecting ditch 1 through a second inlet ditch 28, and a second end of the second treatment pool 22 is communicated with the adjacent treatment unit 2 or the water storage tank 3 through a second outlet ditch 29. A first end of the guiding ditch 23 is communicated with the first treatment pool 21, and a second end of the guiding ditch 23 is communicated with the second treatment pool 22. A connection position between the guiding ditch 23 and the first treatment pool 21 is lower than the water outlet. The control valve 24 is arranged between the guiding ditch 23 and the first treatment pool 21, and is configured to control connection and disconnection between the first treatment pool 21 and the guiding ditch 23. The control unit 25 is connected with the first inlet ditch 26 and the second inlet ditch 28. And the control unit 25 is electrically connected with the control valve 24, and is configured to control connection and disconnection between the collecting ditch 1 and the first inlet ditch 26, and connection and disconnection between the collecting ditch 1 and the second inlet ditch 28, respectively.

In normal operation, a flow path of sewage is as follows: the first inlet ditch 26—the first treatment pool 21—the guiding ditch 23—the second treatment pool 22—the second outlet ditch 29. When cleaning the first treatment pool 21, the control unit 25 is started to connect the collecting ditch 1 and the second inlet ditch 28 and close a connection between the collecting ditch 1 and the first inlet ditch 26, at this time, the flow path of sewage is as follows: the second inlet ditch 28—the second treatment pool 22—the second outlet ditch 29. When cleaning the second treatment pool 22, the control unit 25 is started to connect the collecting ditch 1 and the first inlet ditch 26 and close a connection between the collecting ditch 1 and the second inlet ditch 28, at the same time, the control valve 24 is started to disconnect a signal between the first treatment pool 21 and the guiding ditch 23, at this time, the flow path of sewage is as follows: the first inlet ditch 26—the first treatment 21—the first outlet ditch 27. Such setting mode can repair and clean the treatment unit 2 in time without affecting a water treatment process and ensure a water treatment effect.

In an embodiment, a structure of the rural wastewater recycling device provided herein is basically the same as a structure of the rural wastewater recycling device in the above embodiment, except that the rural wastewater recycling device further includes a sludge-removing assembly 5 connected with the plurality of treatment units 2. The sludge-removing assembly 5 includes a shovel 51, a support rod 52, a transmission rod 53 and a first drive component 54. The shovel 51 is provided in the first treatment pool 21 or the second treatment pool 22, and is configured to remove sludge in the first treatment pool 21 or the second treatment pool 22. The support rod 52 is slidably connected with the shovel 51. The support rod is provided with a support sliding hole. The shovel 51 is provided through the support rod 52 through the support sliding hole, and is configured to slide along a direction perpendicular to the support rod 52. The transmission rod 53 is connected with the support rod 52 through threads. The number of the transmission rod 53 is two, and two transmission rods 53 are respectively provided at two sides of the first treatment pool 21 or two sides of the second treatment pool 22. The two transmission rods 53 are configured to drive the support rod 52 to move along an arrangement direction of the two transmission rods 53. And the first drive component 54 is connected with the two transmission rods 53, and is configure to drive the two transmission rods 53 to rotate.

In this embodiment, the sludge-removing assembly 5 further includes a solar battery 55. The solar battery 55 is electrically connected with the first drive component 54, and is configured for the drive component 5 to work. The first drive component 54 can be a motor. The motor is configured to drive the two transmission rods 53 to rotate, and the two transmission rods 53 are configured to drive the support rod 52 to drive the shovel 51 to move, so that sediment, such as sludge, in the treatment pools are removed. The sludge-removing assembly 5 further includes a jacking part 56 provided on the support rod 52. The jacking part 56 can be a cylinder. The jacking part 56 is connected with the shovel 51 through a rod or a rope, and is configured to drive the shovel 51 to move up and down.

In an embodiment, a structure of the rural wastewater recycling device is basically the same as a structure of the rural wastewater recycling device in the above embodiment, except that the biological purification assembly 4 includes a filter mesh box 41, a filter ball 42 and a plant filter layer 43. The filter mesh box 41 is connected with the first treatment pool 21 or the second treatment pool 22. Both the first treatment pool 21 and the second treatment pool 22 are provided with a mounting groove fitting the filter mesh box 41. The filter mesh box 41 is provided with an accommodating cavity 411. The filter ball 42 is provided in the accommodating cavity 411, and is configured to filter wastewater. The filter ball 42 is a granular filter material with small particle size, and a surface of the granular filter material is attached with a bio-film. The filter ball 42 is the prior art and will not be described in detail herein. The plant filter layer 43 is provided in the accommodating cavity 411 and floating on a water surface. And the plant filter layer 43 is configured to filter wastewater.

In this embodiment, a connection of the first treatment pool 21 and the first inlet ditch 26 is removably connected with a filter screen. The filter screen is configured to filter large debris to protect the biological purification assembly 4 from being damaged by the large debris entering the first treatment pool 21. A connection of the second treatment pool 22 and the second inlet ditch 28 is also removably connected with the filter screen. The rural wastewater recycling device further includes a new energy battery. The new energy battery is configured to convert solar energy or wind energy into electric energy for the treatment unit 2 and an aerator 6.

In an embodiment, a structure of the rural wastewater recycling device provided herein is basically the same as a structure of the rural wastewater recycling device in the above embodiment, except that the shovel 51 includes a support body 511 and a shovel body 512. The support body 511 includes a first sliding part, a first support part and a second support part. The first sliding part is slidably connected with the support rod 52. An end of the first sliding part is provided with a tab in snap-fit with the support rod 52. The first support part is integrally formed with the first sliding part and the second support part. The first support part is perpendicular to the second support part. The first support part is provided with a support sliding groove. A cross section of one end of the second support part away from the first support part is smaller than a cross section of the other end of the second support part. The shovel body 512 includes a second sliding part and a shoveling part. The second sliding part is slidably connected with the support body 511 through the support sliding groove. The second sliding part is integrally formed with the shoveling part. The second sliding part is perpendicular to the first support part. The shoveling part is perpendicular to the second sliding part, and an end of the shoveling part away from the second sliding part is provided with a shoveling slope.

When the shovel 51 is pressed down onto the sludge, the support body 511 can be easily inserted into the sediment because of setting of the shoveling slope. The sediment lifts the shovel body 512, and the support rod 52 drives the support body 511 to move and push the sediment to one side. When the shovel 51 is moved to an initial position, the shovel body 512 automatically slides to the bottom and move to contact with the sediment along with the support body 511, so as to scoop up the sediment. The jacking part 56 pulls up the shovel 51 and then removes the sediment, so as to realize cleaning of the sludge in the treatment pool.

In this embodiment, the sludge-removing assembly 5 is provided with the aerator 6 connected with the support rod 52. The aerator 6 is communicated with the support body 511 through a pipeline. The support body 511 is provided with a plurality of aeration holes. The support body 511 is provided with an aeration cavity communicated with the aerator 6 and the plurality of aeration holes. The aerator 6 is configured to generate gas and transmit the gas to water through the aeration cavity and the plurality of aeration holes to increase an oxygen content of the water. The aerator 6 herein, as long as it can realize above performances, shall be within the scope of this application.

In an embodiment, a structure of the rural wastewater recycling device provide herein is basically the same as a structure of the rural wastewater recycling device in the above embodiment, except that the control unit 25 includes a first support frame 251, a first isolation block 252, a second support frame 253, a second isolation block 254, a control frame 255, a control belt 256, a second drive component 257, a first connecting rope 258 and a second connecting rope 259. The number of the first support frame 251 is two. Two first support frames 251 are provided at two sides of the first inlet ditch 26. Each of the two first support frames 251 is provided with a first sliding groove, and each of the two first support frames 251 is rotatably connected with a first pulley. The first isolation block 252 is provided in the first inlet ditch 26, and the first isolation block 252 is slidably connected with the two first support frames 251 through the first sliding groove. The first isolation block 252 is provided with a first slip ring. The number of the second support frame 253 is two. Two second support frames 253 are provided at two sides of the second inlet ditch 28. Each of the two second support frames 253 is provided with a second sliding groove, and each of the two second support frames 253 is rotatably connected with a second pulley. The second isolation block 254 is provided in the second inlet ditch 28, and the second isolation block 254 is slidably connected with the two second support frames 253 through the second sliding groove. The second isolation block 254 is provided with a second slip ring. The control frame 255 is provided between the first inlet ditch 26 and the second inlet ditch 28. The control frame 255 is provided with a plurality of rotating shafts side by side along a setting direction of the first sliding groove. The control belt 256 is connected to the plurality of rotating shafts at the same time. The control belt 256 can be a chain, and the plurality of rotating shafts are provided with gears or sprockets fitting the chain. The second drive component 257 is connected with the control belt 256, and is configured to drive the control belt 256 to rotate. A first end of the first connecting rope 258 is fixedly connected with the first pulley on a side of the first inlet ditch 26 away from the second inlet ditch 28, and a second end of the first connecting rope 258 passes through the first slip ring, by passes the first pulley on the other side of the first inlet ditch 26 and is connected with a first side of the control belt 256. A first end of the second connecting rope 259 is fixedly connected with the second pulley on a side of the second inlet ditch 28 away from the first inlet ditch 26, and a second end of the second connecting rope 259 passes through the second slip ring, by passes the second pulley on the other side of the second inlet ditch 28 and is connected with a second side of the control belt 256. And the control belt 256 is configured to control the second connecting rope 259 to move in an opposite direction to the first connecting rope 258.

In this embodiment, the first connecting rope 258 and the second connecting rope 259 are removably connected with the control belt 256. A size of an opening between the isolation blocks and the inlet ditches is controlled by controlling a position of the connecting ropes on the control belt 256, so as to control the water quantity. The second drive component 257 can be a motor. When working, the motor is started to control the first connecting rope 258 and the second connecting rope 259 to move at the same time through the control belt 256, so as to drive the first isolation block 252 to move in an opposite direction to the second isolation block 254 to realize connection and disconnection between the first inlet ditch 26 and the second inlet ditch 28.

It should be understood that as used herein, the orientation or position relationship indicated by the terms “length”, “width”, “up”, “down”, “front”, “back”, “left”, “right”, “vertical”, “horizontal”, “top”, “bottom”, “inside”, and “outside”, is based on the orientation or position relationship shown in the accompanying drawings, and are only for facilitating and simplifying the description rather than indicating or implying that the devices or components must have a particular orientation, or be constructed and operated in a particular orientation, therefore, they can't be understood as a limitation of this application.

Individual embodiments provided herein are described in a progressive way. Individual embodiments mainly focus on the differences from other embodiments, and the same or similar parts can be referred to each other. Contents not described in detail in the embodiments of the present disclosure belong to the prior art known to those skilled in the art.

The above description of the embodiments of the present disclosure is intended to enable those skilled in the art to implement or use the present disclosure, rather than limiting the present disclosure. It should be understood that various modifications, variations and replacements made by those skilled in the art without departing from the spirit or scope of the present disclosure shall fall within the scope of the disclosure defined by the appended claims.

What is claimed is:

1. A method for recycling rural wastewater, comprising:
(S1) setting a collecting ditch and a first treatment pool for collecting wastewater around a rural yard; according to a discharge capability Q_{ditch} and a discharge destination of the collecting ditch, determining a gradient of the collecting ditch; wherein the discharge destination comprises the first treatment pool, a river channel and a pond;
(S2) according to a layout and regional topography of the rural yard, arranging n second treatment pools respectively in n levels at a position near the rural yard and lower than the rural yard, wherein bottom elevations of the n second treatment pools are descending with an increase in wastewater treatment degree; volumes of the n second treatment pools are V₁ₗᵢₘ, V₂ₗᵢₘ, V₃ₗᵢₘ, . . . , and Vₙₗᵢₘ, and Vᵢₗᵢₘ=Sᵢ·Hᵢₗᵢₘ, wherein i=1, 2, 3, . . . , n; Sᵢ represents a base area of an i-th second treatment pool; and Hᵢₗᵢₘ represents a maximum water level of the i-th second treatment pool; a total water quantity limit of the n second treatment pools is Q_{total lim}, and Q_{total lim}=Σᵢ₌₁ⁿVᵢ·ρ=Q_{ditch}, wherein p represents density of water;
(S3) obtaining water storage information of each of the n second treatment pools; and according to the water storage information and the maximum water level, recycling or discharging water in the n second treatment pools in time;
(S4) calculating a total water demand; according to the total water demand, determining total water storage information of the n second treatment pools, wherein the total water demand is calculated by Rₜₒₜₐₗ=R_{ecology}+R_{flushing}+R_{aquaculture}, wherein R_{ecology}=S·h·(θfc−θwilting), and R_{ecology}, represents an ecological water demand of plants around the collecting ditch and the n second treatment pools; R_{flushing} and R_{aquaculture} respectively represents flush water demand and aquaculture water demand for meeting water quality requirements; θfc represents soil saturated water-holding capacity; and θ_{wilting} represents soil wilting water content; and
(S5) according to water quality, water quantity and environmental protection situations, controlling a total duration T of an operation cycle of collected domestic wastewater between the n second treatment pools and the collecting ditch; and recycling treated wastewater reaching standard or discharging the treated wastewater reaching standard to the river channel or pond.

2. The method of claim 1, wherein the discharge capability Q_{ditch} of the collecting ditch is calculated as follows:
$$\begin{matrix}{Q}_{ditch} = max ( {Q}_{r a i n} , {Q}_{s e w a g e} ) ; \\ {Q}_{rain} = α \cdot A \cdot q ; \\ {Q}_{sewage} = {Q}_{c s} + {Q}_{d s} ; and \\ {Q}_{d s} = K \cdot {q}_{quota} \cdot N ;\end{matrix}$$
wherein Qᵣₐᵢₙ represents rainfall; a represents runoff coefficient; A represents catchment area; q represents rainfall intensity; K represents sewage discharge coefficient; q_{quota} represents domestic sewage quota; Q_{cs}, represents culture sewage quantity; Q_{ds} represents domestic sewage quantity; and N represents population size.

3. The method of claim 2, wherein step (S5) comprises:
in the case of no rain, performing wastewater treatment in accordance with a conventional operation cycle T; adopting part of treated wastewater reaching flushing or greening standard for plant irrigation, flushing or culture, and maintaining a certain water level in the collecting ditch and the n second treatment pools; and
in the case of rainfall, according to drainage requirements, shortening the operation cycle T; filtering collected rainwater, and discharging excess wastewater reaching standard to the river channel or pond; wherein the operation cycle T is calculated as follow: T=Σᵢ₌₁ⁿtᵢ; wherein tᵢ is residence time of collected domestic wastewater in the i-th second treatment pool, and i=1, 2, 3, . . . , n.

4. A rural wastewater recycling device applied to the method of claim 1, comprising:
the collecting ditch;
a moving cover;
a plurality of treatment units;
a water storage tank; and
a biological purification assembly;
wherein the collecting ditch is configured for connection with a wastewater generation site, and a cross section of the collecting ditch is trapezoidal; the moving cover is connected with the collecting ditch; adjacent treatment units of the plurality of treatment units are communicated with each other; one of the plurality of treatment units located at a first end is connected with the collecting ditch; and for two adjacent treatment units among the plurality of treatment units, a treatment unit close to the wastewater generation site is higher than the other treatment unit; one of the plurality of treatment units located at a second end is communicated with the water storage tank; the water storage tank is configured to store treated water; the biological purification assembly is connected with the plurality of treatment units, and is configured to purify wastewater flowing through the plurality of treatment units.

5. The rural wastewater recycling device of claim 4, wherein each of the plurality of treatment units comprises:
a first treatment pool;
a second treatment pool;
a guiding ditch;
a control valve; and
a control unit;
wherein a first end of the first treatment pool is communicated with the collecting ditch through a first inlet ditch, and a second end of the first treatment pool is communicated with an adjacent treatment unit or the water storage tank through a first outlet ditch; the first outlet ditch is communicated with the first treatment pool through a water outlet;
a first end of the second treatment pool is communicated with the collecting ditch through a second inlet ditch, and a second end of the second treatment pool is communicated with the adjacent treatment unit or the water storage tank through a second outlet ditch;
a first end of the guiding ditch is communicated with the first treatment pool, and a second end of the guiding ditch is communicated with the second treatment pool; a connection position between the guiding ditch and the first treatment pool is lower than the water outlet;
the control valve is arranged between the guiding ditch and the first treatment pool, and is configured to control connection and disconnection between the first treatment pool and the guiding ditch; and
the control unit is connected with the first inlet ditch and the second inlet ditch; and the control unit is electrically connected with the control valve, and is configured to control connection and disconnection between the collecting ditch and the first inlet ditch, and connection and disconnection between the collecting ditch and the second inlet ditch, respectively.

6. The rural wastewater recycling device of claim 5, further comprising:
a sludge-removing assembly connected with the plurality of treatment units;
wherein the sludge-removing assembly comprises:
a shovel;
a support rod;
a transmission rod; and
a drive component;
wherein the shovel is provided in the first treatment pool or the second treatment pool, and is configured to remove sludge in the first treatment pool or the second treatment pool; the support rod is slidably connected with the shovel; the support rod is provided with a support sliding hole; the shovel is provided through the support rod through the support sliding hole, and is configured to slide along a direction perpendicular to the support rod; the transmission rod is connected with the support rod;
the number of the transmission rod is two, and two transmission rods are respectively provided at two sides of the first treatment pool or two sides of the second treatment pool; the two transmission rods are configured to drive the support rod to move along an arrangement direction of the two transmission rods; and the drive component is connected with the two transmission rods, and is configure to drive the two transmission rods to rotate.

7. The rural wastewater recycling device of claim 6, wherein the biological purification assembly comprises:
a filter mesh box;
a filter ball; and
a plant filter layer;
wherein the filter mesh box is connected with the first treatment pool or the second treatment pool; both the first treatment pool and the second treatment pool are provided with a mounting groove fitting the filter mesh box; the filter mesh box is provided with an accommodating cavity; the filter ball is provided in the accommodating cavity, and is configured to filter wastewater; the plant filter layer is provided in the accommodating cavity and floating on a water surface; and the plant filter layer is configured to filter wastewater.

8. The rural wastewater recycling device of claim 7, wherein the shovel comprises:
a support body; and
a shovel body;
wherein the support body comprises a first sliding part, a first support part and a second support part; the first sliding part is slidably connected with the support rod; an end of the first sliding part is provided with a tab in snap-fit with the support rod; the first support part is integrally formed with the first sliding part and the second support part; the first support part is perpendicular to the second support part; the first support part is provided with a support sliding groove; a cross section of one end of the second support part away from the first support part is smaller than a cross section of the other end of the second support part; and
the shovel body comprises a second sliding part and a shoveling part; the second sliding part is slidably connected with the support body through the support sliding groove; the second sliding part is integrally formed with the shoveling part; the second sliding part is perpendicular to the first support part; the shoveling part is perpendicular to the second sliding part; and an end of the shoveling part away from the second sliding part is provided with a shoveling slope.

9. The rural wastewater recycling device of claim 8, wherein the moving cover is made of straw or wrapped plant ash; and/or
the collecting ditch is an integrated ecological slope whose materials comprise shrub, stone and brick.

10. The rural wastewater recycling device of claim 9, wherein the sludge-removing assembly is provided with an aerator connected with the support rod; the aerator is communicated with the support body through a pipeline; and the support body is provided with a plurality of aeration holes.
